(19) United States
(12) Patent Application Publication
(10) Pub. No.: US 2020/0387916 A1
(43) Pub. Date: Dec. 10, 2020

(54) INTELLIGENT VOLUME PROFILE CHARTING DEVICE AND METHOD THEREOF

(71) Applicant: HAN-MING HSIEH, HSINCHU CITY (TW)

(72) Inventor: HAN-MING HSIEH, HSINCHU CITY (TW)

(21) Appl. No.: 17/002,172

(22) Filed: Aug. 25, 2020

Related U.S. Application Data
(63) Continuation-in-part of application No. 15/809,201, filed on Nov. 10, 2017.

(51) Int. Cl. G06Q 30/02; G06T 11/20

(52) U.S. Cl. CPC G06Q 30/0201; G06T 11/206

(57) ABSTRACT

An intelligent Volume Profile charting device and method thereof for charting a tradable object are provided. A price-and-volume displaying module displays a level bar chart segmented to a plurality of volume bars corresponding to a plurality of price intervals. A featured-price-and-volume level module quantizes the featured prices to full-length level bar and quantizes the non-featured prices to zero-length level bars. A combining-and-generating module combines the full-length level bars and the zero-length level bars into at least one full volume block and at least one zero volume block. Investors could invest tradable objects more efficiently and effectively based on intelligent charts and calculations of entry point, exit point and expected return.

### FIELD OF THE INVENTION

The present invention provides computer-based systems and methods, especially directed to intelligent volume profile charting tradable objects.

### BACKGROUND OF THE INVENTION

Technical analysis attempts to understand the market sentiment behind price trends by looking for patterns and trends rather than analyzing a security's fundamental attributes.

Originally, technical analysis was a largely a matter of “reading the tape” or interpreting the successive flow and magnitude of price and volume data through a stock ticker. As computers became more widespread in the 1970s, data was compiled into chart form and became a technician's standard point of reference.

Recognition of chart patterns and bar (or later candlestick) analysis were the most common forms of analysis, followed by regression analysis, moving averages, and price correlations. Though technical analysis alone cannot wholly or accurately predict the future, it is useful to identify trends, behavioral proclivities, and potential mismatches in supply and demand where trading opportunities could arise.

Charting is nothing more than predicting the direction of a price between significant support and resistance levels. A support level is a price level which a stock has had difficulty falling below. This is where a lot of buyers tend to enter the stock. Similarly, resistance is a price level above which a stock has difficulty climbing. This is where a lot of buyers take profits and shorts enter. Typically, a stock's price will range between these levels until it breaks out or breaks down. Hundreds of different methods can be used to locate these areas of support and resistance, one of the most preferred methods is using Volume Profile or Volume-by-Price charts.

Volume Profile or Volume-by-Price is an indicator that shows the amount of volume for a specific price range, which is based on closing prices. Volume Profile or Volume-by-Price bars are horizontal and shown on the left side of the chart to correspond with these price ranges. By combining or overlaying volume and closing prices, current investors use this indicator to identify high-volume price ranges to mark support or resistance. Common practice for application of Volume Profile or Volume-by-Price method were: Long Volume Profile or Volume-by-Price bars underneath prices will be treated as potential support during a pullback and long Volume Profile or Volume-by-Price bars above prices will be treated as potential resistance on a bounce. Price breaks above or below long Volume Profile or Volume-by-Price bars will be used as entry and exit points signals. A break above a long bar shows strength and thus deemed as an entry point because demand was strong enough to overcome a supply overhang and a break below a long bar shows weakness and thus deemed as an exit point because supply was ample enough to overwhelm demand.

Insufficiency and shortcomings of current Volume Profile or Volume-by-Price investment system and method are listed as the followings:

(i) Entry and exit points determinations are vague and subjective. Morphology of Volume Profile chart or Volume-by-Price chart will be different which was dependent on selected time period and selected segments numbers of specific price range. FIG. 1A and FIG. 1B are schematic views of conventional Volume Profile charts with different time period selected. With reference to FIG. 1A, a conventional Volume Profile chart is provided with a time period “2017/12/16˜2020/06/03” and segments numbers “36” of price interval “5.75˜13” selected. With reference to FIG. 1B, another conventional Volume Profile chart is provided with a time period “2016/10/14˜2020/06/03” and segments numbers “36” of price interval “5.75˜13” selected. Comparing FIG. 1A with FIG. 1B, it can be seen that the bars distribution are total different while different time periods are selected even under the same segments numbers of same price interval.

FIG. 1C is the other schematic view of conventional Volume Profile chart with different segments numbers of specific price interval selected. With reference to FIG. 1C, the other conventional Volume Profile chart is provided with a time period “2017/12/16˜2020/06/03” and segments numbers “18” of price interval “5.75˜13” selected. Comparing FIG. 1A with FIG. 1C, it can be seen that although the same time period is selected, the Volume Profile charts with different segments numbers selected will also cause total different bars distribution.

That is to say, either different time period selected, or different segments numbers of specific price interval selected will render completely different bars distribution. Determinations of break points or entry and exit points become very subjective and vague. Thereby, when a user wants to determine entry and exit points from Volume Profile charts of FIG. 1A˜1C, the results will be total different and uncertain, such that the determinations are vague and subjective.

(ii) Prediction of expected return was incapable. Current Volume Profile or Volume-by-Price investment system and method cannot predict the expected return of investment under the uncertain results as above mentioned.

This present invention overcome the shortcomings and insufficiency of the conventional technologies by providing a computer-based systems and methods directed to intelligent volume profile charting device and method thereof to effectively overcome the aforementioned problems.

### SUMMARY OF THE INVENTION

The primary objects of the present invention is to provide an intelligent Volume Profile charting device and method thereof to objectively charting Volume Profile chart or Volume-by-Price chart, such that entry and exit points determinations are certain and objective.

Another object of the present invention is to provide an intelligent Volume Profile charting device and method thereof that is able to predict expected return.

To achieve the aforementioned objective, the present invention provides an intelligent Volume Profile charting device for charting a tradable object of financial instruments applied to a computer with a display. The intelligent Volume Profile charting device includes an information receiving module, a price-and-volume displaying module, a customized combination module, a featured-price-and-volume level module, a combining-and-generating module and an information displaying module. The information receiving module receives a financial information message of at least one external financial instrument. The price-and-volume displaying module displays a level bar chart of the tradable object with multiple price-and-volume information messages of the financial instruments according to the financial information message, wherein the multiple price-and-volume information messages are segmented to a plurality of volume bars corresponding to a plurality of price intervals. The customized combination module defines a plurality of predetermined values corresponding to the price intervals to generate a combination information message, wherein the combination information message comprises a volume-defining level information message. The featured-price-and-volume level module receives the multiple price-and-volume information messages, and defines the price-and-volume information message being larger than corresponding one of the predetermined values of a trade volume condition as a featured price, wherein the featured-price-and-volume level module quantize each of the featured prices to a full-length level bar and quantize each of non-featured prices to a zero-length level bar to generate a featured-price-and-volume level information message according to the volume-defining level information message of the combination information message. The combining-and-generating module combines the full-length level bars and the zero-length level bars of the featured-price-and-volume level information message into at least one full volume block and at least one zero volume block to generate a featured-price-and-volume block information message. The information displaying module generates and displays a comprehensive featured-price-and-volume block chart in the display according to the financial information message, the featured-price-and-volume level information message, and the featured-price-and-volume block information message.

Furthermore, the present invention also provides an intelligent Volume Profile charting method for charting a tradable object of financial instruments includes following steps.(a) generating an activating signal and starting to receive at least one external financial information message according to the activating signal and displaying a level bar chart of the tradable object with multiple price-and-volume information messages of the financial instruments according to the financial information message, wherein the multiple price-and-volume information messages are segmented to a plurality of volume bars corresponding to a plurality of price intervals; (b) defining a plurality of predetermined values corresponding to the price intervals to generate a combination information message comprising a volume-defining level information message; (c) defining the price-and-volume information message being larger than corresponding one of the predetermined values of a trade volume condition as a featured price and quantizing each of the featured prices to a full-length level bar, each of non-featured prices to a zero-length level bar to generate a featured-price-and-volume level information message according to the volume-defining level information message; (d) combining the full-length level bars and the zero-length level bars to form at least one full volume block and at least one zero volume block to generate at least one featured-price-and-volume block information message; and (e) generating a comprehensive featured-price-and-volume block chart according to the financial information message, the featured-price-and-volume level information message and the featured-price-and-volume block information message.

Detailed descriptions are presented by embodiments as follows. Hereby the objectives, technical contents, features and achieved effects of the present invention will be more easily understood.

### DESCRIPTION OF THE DRAWINGS

FIG. 1A is a schematic view of conventional Volume Profile chart;

FIG. 1B is another schematic view of conventional Volume Profile chart with different time period selected;

FIG. 1C is the other schematic view of conventional Volume Profile chart with different segments numbers of specific price interval selected;

FIG. 2 is a schematic view of a block diagram for a system of the present invention;

FIG. 3 is a schematic bar chart view of a price-and-volume information message of the present invention;

FIG. 4 is a schematic view of the marked featured price of the present invention.

FIG. 5 is a schematic level bar chart view of the featured-price-and-volume level information message of the present invention;

FIG. 6 is schematic view of a first quantizing matrix operation;

FIG. 7 is a schematic block chart view of a combined featured-price-and-volume block information message of the present invention;

FIG. 8 is schematic view of a second quantizing matrix operation;

FIG. 9 is a schematic view of a similarity table corresponding to different time intervals;

FIG. 10 is a schematic view of the weighted price-and-volume information message of the present invention;

FIG. 11 is a schematic view of a long-term average price information message of the present invention;

FIG. 12 is a schematic view of a flowchart of a method of the present invention;

FIG. 13 is a schematic view of displayed information options of the present invention;

FIG. 14 is a schematic weighted bar chart view of the marked weighted featured price of the present invention;

FIG. 15 is a schematic weighted level bar chart view of the weighted featured-price-and-volume level information message of the present invention;

FIG. 16 is a schematic weighted block chart view of the weighted combined featured-price-and-volume block information message of the present invention; and

FIG. 17 is a schematic view of a comprehensive featured-price-and-volume block chart of the present invention.

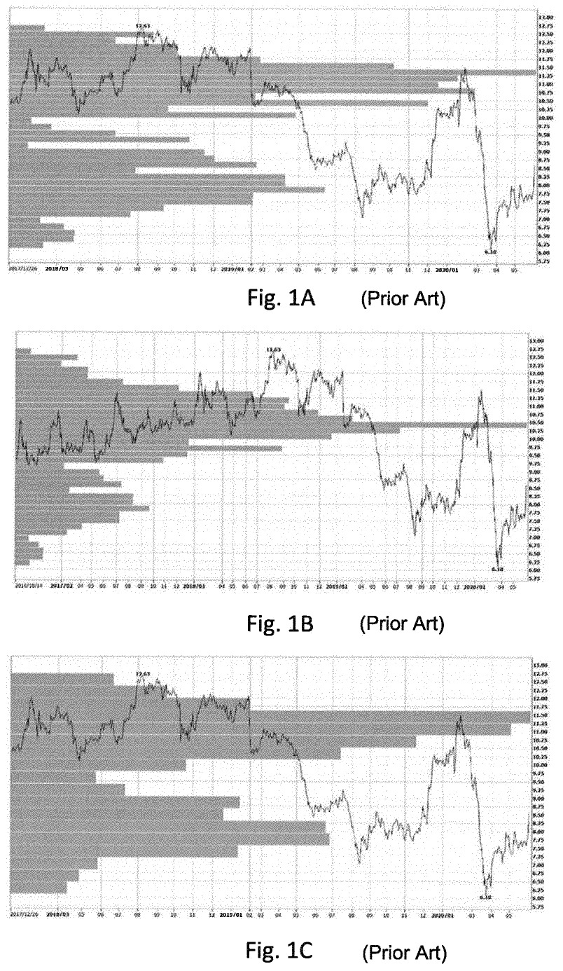

### DETAILED DESCRIPTION OF THE PREFERRED EMBODIMENTS

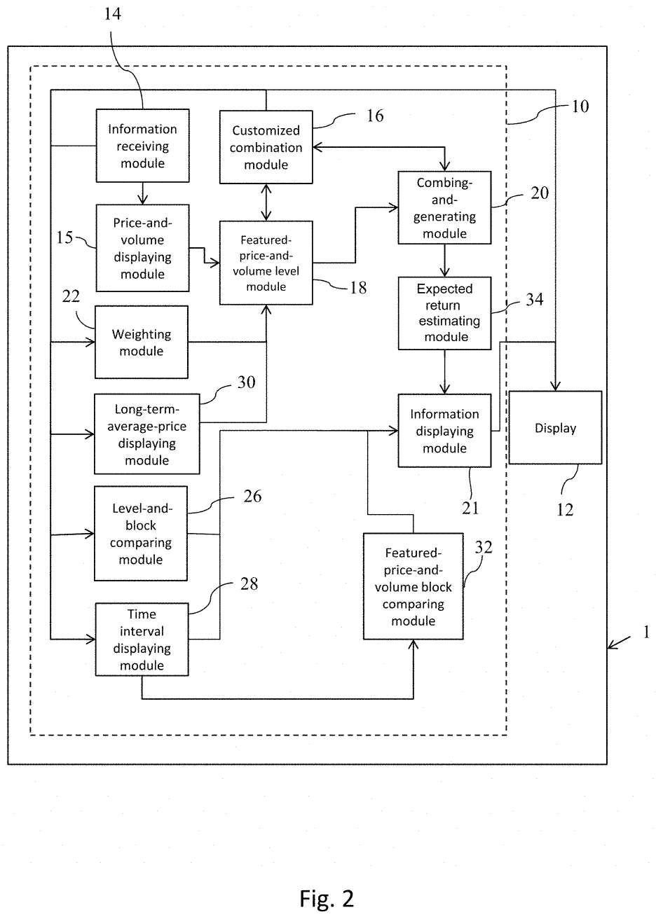

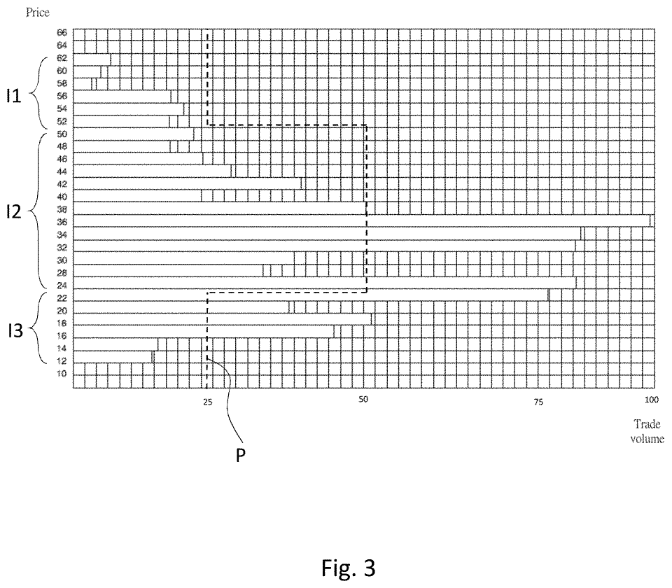

With reference to FIG. 2, as shown in the figure, a trade data processing device for financial instruments in accordance with the present invention is used in a computer 1. The computer 1 comprises a processing unit 10 and a display 12. The trade data processing device for financial instruments in accordance with the present invention is disposed in the processing unit 10 and comprises an information receiving module 14 for receiving a financial information message of at least one external financial instrument. The information receiving module 14 may be a wired or wireless signal receiver to receive wired or wireless signals. The financial instruments are stocks, currency, bonds, options, futures, Exchange Traded Funds (ETF) or interest rates, etc. The information receiving module 14 is electrically connected to a price-and-volume displaying module 15 such that the information receiving module 14 transmits the financial information message to the price-and-volume displaying module 15, and then displays multiple price-and-volumes according to multiple price-and-volume information messages of the financial information message. A displayed price-and-volume is shown as a bar chart in FIG. 3, according to each price-and-volume of the financial instruments, distributed bar graphics are presented. Each bar graphic in the chart indicates a different price interval, a length of the bar graphic indicates trade volume. A customized combination module 16 is electrically connected to the display 12 to generate multiple displayed information options and displays the displayed information options in the display 12 to allow a user to select at least one of the displayed information options. The customized combination module 16 generates a combination information message according to the displayed information option selected by the user. The combination information message comprises one of a volume-defining level information message, a weighting module information message, a featured-price-and-volume block comparison information message, a level-and-block comparison information message, a long-term average price display information message, a time interval display information message and a combination thereof.

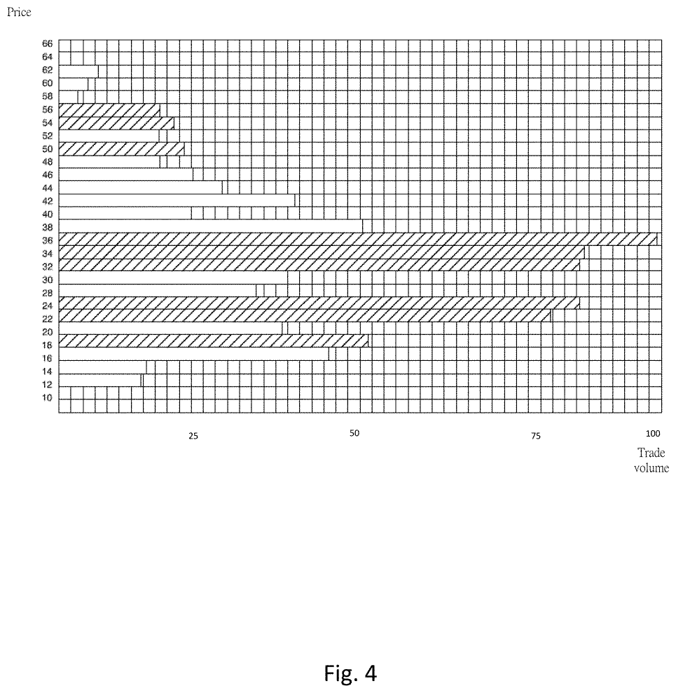

A featured-price-and-volume level module 18 is electrically connected to customized combination module 16 to receive the volume-defining level information message of the combination information message and the multiple price-and-volume information messages of the financial instruments, to determine a level of the multiple price-and-volume information messages of the financial instruments according to the information message defined in the volume-defining level information message to generate a featured-price-and-volume level information message. The volume-defining level information message comprises at least one predetermined value of a trade volume condition to define whether the multiple price-and-volume information messages are the featured price by the predetermined value of the trade volume condition. The predetermined value of the trade volume condition may be defined by the user himself/herself, or the information receiving module 14 may further constantly receive multiple historical trade data of the financial instruments, studies from these data by neural networks and machine learning and then implements recursive back tests to determine the best predetermined value of the trade volume condition for the user's reference. With reference FIG. 4, a chart shows that the feature-price-and-volume level module 18 of the present invention determines the featured price and generates featured price. In the chart each bar graphic indicates a different price interval. A length of the bar graphic indicates a trade volume. When the user is operating the customized combination module 16, according to the user's predetermined value for defining a trade volume condition, a price-and-volume information message being larger than the predetermined value of the trade volume condition is defined as a featured price. In the present embodiment, for example, the predetermined value of the trade volume condition for a price from 18 to 40 is 50, a trade volume of the predetermined value of the trade volume condition for a price from 50 to 64 is 25. Therefore, the price-and-volume information message including the trade volume over 50 for the price from 18 to 40 and the trade volume over 25 for the price from 50 to 64 will be deemed as a featured price.

Furthermore, the customized combination module 16 may alternatively define the predetermined values according to a normal distribution corresponding to the price intervals. The normal distribution can be simplified as the broken line P in FIG. 3 shows. With reference to FIG. 3, the price-and-volume information message can be divided into 3 parts I1, I2 and I3. The top one quarter part I1 (6 bars included) is assigned with a predetermined value of ¼ max volume (25 in this case). The middle half part I2 (13 bars included) is assigned with a predetermined value of ½ max volume (50 in this case). The bottom one quarter part I3 (6 bars included) is assigned with a predetermined value of ¼ max volume (25 in this case). Therefore, the price-and-volume information message including the trade volume over 25 for the price interval from 12 to 24, the trade volume over 50 for the price from 24 to 52 and the trade volume over 25 for the price interval from 52 to 62 will be deemed as a featured price. In other embodiments, the predetermined values according to the normal distribution can be modified by the skilled person in the art, and it should not be restricted as the embodiment described.

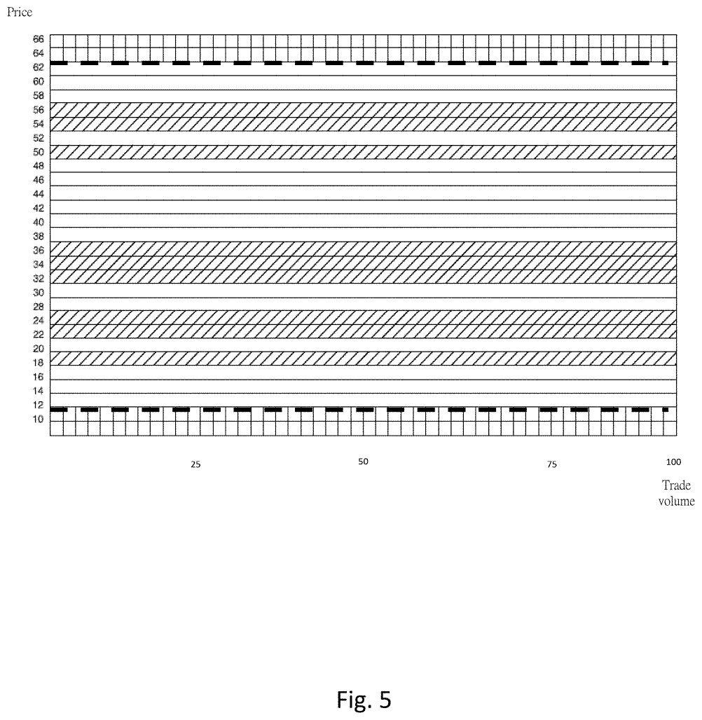

As shown in FIG. 4, the bar graphics with slash lines indicates the featured prices. After the featured prices are obtained, the featured-price-and-volume level module 18 may integrate the featured prices, and first quantizes the bar graphics of the feature prices and non-featured prices. In other words, the trade volume of the featured price is quantized as 100 (a full-length level bar), the trade volume of the non-featured price is quantized as 0 such that the featured-price-and-volume level information message, featured-price-and-volume level information message are generated, as shown in FIG. 5.

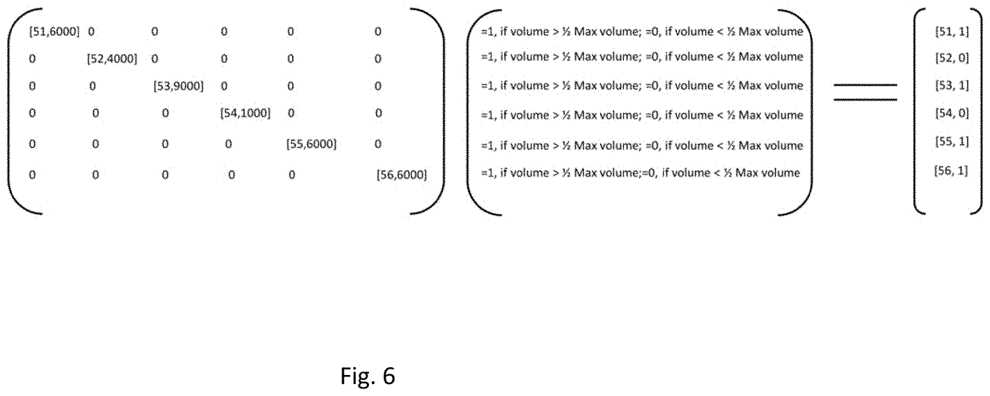

FIG. 6 is schematic view of a first quantizing matrix operation. With reference to FIG. 6, the featured-price-and-volume level module 18 may use the first quantizing matrix operation to quantize the featured price and non-featured prices according to Heisenberg Quantum Matrix Mechanics. For example, the multiple price-and-volume information messages can be represent as a diagonal matrix, and the element [51, 6000] means a trade volume of 6000 at price 51. In FIG. 6, predetermined value is ½ max volume. If the volume is above ½ max volume (ex. a trade volume of 10000), the element will be quantized to 1(ex. [51, 1]). If the volume is less than ½ max volume, the element will be quantized to 0(ex. [52, 0]).

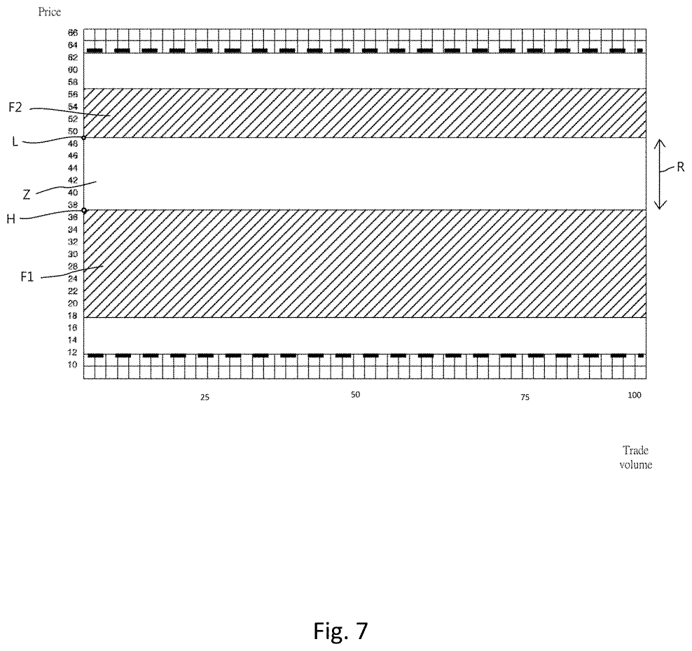

With reference to FIG. 2, the processing unit 10 further comprises a combining-and-generating module 20 electrically connected to the featured-price-and-volume level module 18 and the customized combination module 16 to second quantization according to the featured-price-and-volume level information message. In other words, the multiple featured prices level bars are combined to form at least one featured-price-and-volume block to generate at least one featured-price-and-volume block information message. With reference to FIG. 7, the present embodiment has two featured-price-and-volume blocks (full volume blocks), the blocks with slash lines in FIG. 7. The featured-price-and-volume blocks combine with the non-featured-price-and-volume block (zero volume block) to form the featured-price-and-volume block information message in FIG. 7. In addition to combination of two adjacent featured prices level bars into an integrated featured-price-and-volume block, the present embodiment may also allow the price-and-volume information message with at least one non-featured price located between the two featured prices, to be combined to form an integrated featured-price-and-volume block.

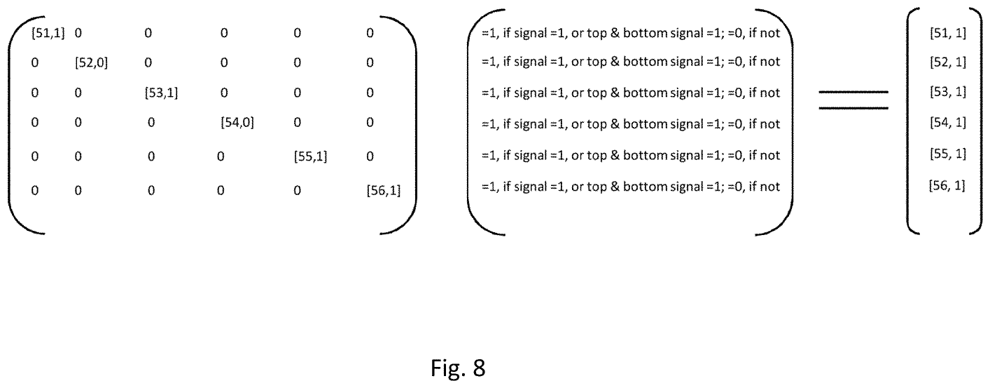

FIG. 8 is schematic view of a second quantizing matrix operation. With reference to FIG. 8, the combining-and-generating module 20 may use the second quantizing matrix operation to iteratively second quantize the result after first quantizing (as shown as FIG. 6). For example, the featured-price-and-volume level information message can be represent as a diagonal matrix, and the element [51, 1] means a signal 1 at price 51. In FIG. 8, if the signal is equal to 1, the element will be quantized to 1(ex. [51, 1]). If top and bottom signals are equal to 1, the element will be quantized to 1(ex. [52, 1]). If the signal does not meet the above condition, the element will be quantized to 0 (not shown in FIG. 8).

For example, a price-and-volume level information message having two or less non-featured prices located between two featured prices level bars may be combined to form an identical featured-price-and-volume block. The featured price-and-volume level information message of the non-featured prices(zero-length level bars) between the two featured prices level bars (full-length level bars) are merged to generate the featured-price-and-volume block information message. An information displaying module 21 electrically connected to the combining-and-generating module 20 and the display 12 such that a comprehensive featured-price-and-volume block chart is generated and shown on the display 12 according to the financial information message, the featured-price-and-volume level information message and the featured-price-and-volume block information message.

In more detail, the combining-and-generating module 20 may iteratively executes four merge operations. In the first merge operation, the combining-and-generating module 20 will keep the highest and the lowest full-length level bars. From bottom to top, the combining-and-generating module 20 will change all the single zero-length level bars into full-length level bars to generate a full volume block. If the highest or the lowest bar is a zero-length level bar, the combining-and-generating module 20 will also change it into full-length level bar.

In the second merge operation, the combining-and-generating module 20 will deal with two zero-length level bars adjacent to each other. If there's two adjacent zero-length level bars located between full-length level bars and the amount of the upper and lower full-length level bars is greater or equal to 4, the combining-and-generating module 20 will change the two adjacent zero-length level bars into full-length level bars. If here's two adjacent zero-length level bars located at the highest or the lowest area and the amount of the upper and lower full-length level bars is greater or equal to 3, the combining-and-generating module 20 will change the two adjacent zero-length level bars into full-length level bars.

In the third merge operation, the combining-and-generating module 20 will deal with three zero-length level bars adjacent to each other. If there's three adjacent zero-length level bars located between full-length level bars and the amount of the upper and lower full-length level bars is greater or equal to 6, the combining-and-generating module 20 will change the three adjacent zero-length level bars into full-length level bars. If here's three adjacent zero-length level bars located at the highest or the lowest area and the amount of the upper and lower full-length level bars is greater or equal to 5, the combining-and-generating module 20 will change the three adjacent zero-length level bars into full-length level bars.

In the fourth merge operation, the combining-and-generating module 20 will deal with four zero-length level bars adjacent to each other. If there's four adjacent zero-length level bars located between full-length level bars; the amount of the upper and lower full-length level bars is greater or equal to 10; the upper and lower full-length level bars is greater or equal to 4; and the proportions of four zero-length level bars are less than 5% (or (max-min)/max<45%), the combining-and-generating module 20 will change the four adjacent zero-length level bars into full-length level bars.

It should be noted that the above merge operations can be modified by the skilled person in the art, and it should not be restricted as the embodiment described.

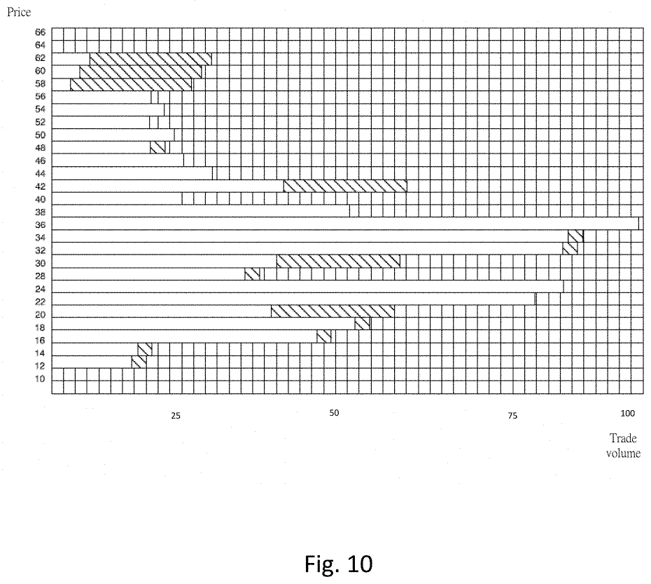

With reference to FIG. 2, the processing unit 10 further comprises a weighting module 22 electrically connected to customized combination module 16 and the featured-price-and-volume level module 18. Before the featured-price-and-volume level module 18 defines the featured price of the price-and-volume information message, the price-and-volumes of different trading object conditions may be weighted. In other words, each price-and-volume may have both a large number of shares per trade order (big trade order) and a small number of shares per trade order (small trade order), and the user is able to define the big order and the small order by himself/herself to give different weights to the big order and the small order. The reasons for differentiating them were the different behaviors they behaved during price movement which is essential. When the customized combination module 16 generates weighting module information message to the weighting module 22, the weighting module 22 weights and adjusts the trade volume of the price-and-volume information message. When the adjustment is implemented, a weighting value may be modified according the current advancing condition or declining condition of the financial instruments. When the price of the financial instruments decreases in the declining condition, the trade volume of the small trade order of the financial instruments is given a negative weighting setting value, and the trade volume of the big trade order of the financial instruments is given a positive weighting setting value. Then the featured-price-and-volume level module 18 defines the multiple weighted price-and-volume information messages as a featured price or a non-featured price; when a price of the financial instruments increases in the advancing condition, the trade volume of the small trade order of the financial instruments is given a positive weighting setting value, and the trade volume of the big trade order of the financial instruments is given a negative weighting setting value. Then the featured-price-and-volume level module 18 defines the multiple weighted price-and-volume information messages as a featured price or a non-featured price. The weighted price-and-volume information message, as shown in FIG. 10, elongates or shortens the bars of the price-and-volume to be weighted, and then the featured-price-and-volume level module 18 defines a level of the multiple weighted price-and-volume information messages. The positive weighting setting value and the negative weighting setting value are both set by the user.

The processing unit 10 further comprises a time interval displaying module 28 electrically connected to customized combination module 16 and the information displaying module 21 to define and display an information of a specific time interval of the financial instruments. When the user selects the time interval in the customized combination module 16 to display, the customized combination module 16 generates time interval display information message to the time interval displaying module 28. The time interval displaying module 28 generates a time interval according to the time interval set by the time interval display information message, and transmits the time interval to the information displaying module 21 to combine with the featured-price-and-volume level information message and the featured-price-and-volume block information message to generate a comprehensive featured-price-and-volume block chart.

The processing unit 10 further comprises a featured-price-and-volume block comparing module 32 electrically connected to the customized combination module 16 and the information displaying module 21 to compare the featured-price-and-volume block information messages of the same financial instrument or the different financial instruments. When the user selects and displays a block chart similarity value in the customized combination module 16 to compare to obtain a similarity of the featured-price-and-volume block information messages(block charts) of the different financial instruments, the customized combination module 16 generates and transmits a block chart similarity value to the information displaying module 21 to combine with the featured-price-and-volume level information message, the featured-price-and-volume block information message to generate a featured price-and-volumes block chart. The featured-price-and-volume block chart comparing module employs a calculating method that calculates the similarity by cosine similarity.

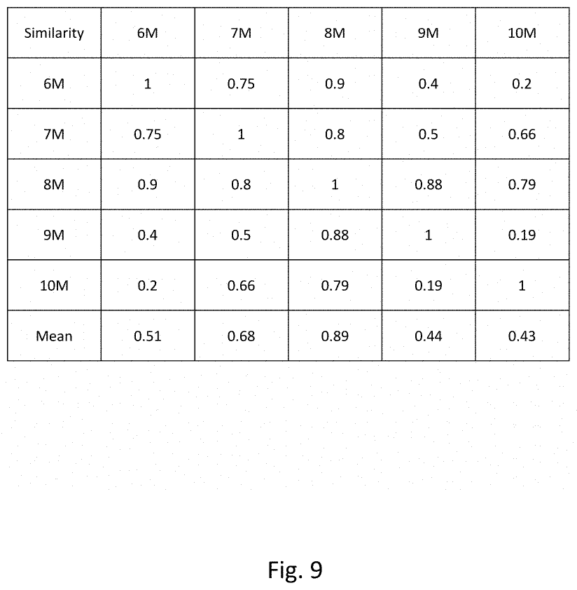

FIG. 9 is a schematic view of a similarity table corresponding to different time intervals. With reference to FIG. 9, the time interval displaying module 32 generates different time intervals (ex. 6 months to 10 months). Then, the customized combination module 16 generates featured-price-and-volume block charts comparison information message corresponding to different time intervals. The featured-price-and-volume block comparing module 32 obtains block chart similarity values between every two of the different featured-price-and-volume block information messages (ex. a block chart similarity value between 6 months to 8 months is 0.9, a block chart similarity value between 7 months to 9 months is 0.5). After the block chart similarity values are obtained, the featured-price-and-volume block comparing module 32 generate and transmit mean values of the block chart similarity values corresponding to the different time intervals respectively to the information displaying module 21. For example, a mean value of the block chart similarity values of 9 months is 0.44).

The featured-price-and-volume block comparing module 32 determines an optimized time interval according to the block chart similarity value. In the embodiment, the optimized time interval can be determined by F(0=max (mean value of similarity(t)). For example, the mean value of similarity of 8 months is 0.89 which is the max one among 6 months to 10 months, and thus the time interval “8 months” is the optimized time interval.

The processing unit 10 further comprises a level-and-block comparing module 26 electrically connected to the customized combination module 16 and the information displaying module 21. The level-and-block comparing module 26 is able to compare to obtain a similarity of the featured-price-and-volume level information message (level bar chart) and the combined featured-price-and-volume block information message (block chart) of the same financial instrument. When the user selects and displays the similarity of the featured-price-and-volume level information message (level bar chart) and the combined comprehensive-featured-price-and-volume block information message (block chart) in the customized combination module 16, the customized combination module 16 generates a level-and-block comparison information message to the level-and-block comparing module 26. The level-and-block comparing module 26 starts to compare to obtain a similarity value of the different trade volume level information messages and the featured-price-and-volume block information messages to generate and transmit a level-and-block similarity value to the information displaying module 21 to combine with the featured-price-and-volume level information message and the featured-price-and-volume information messages to generate a comprehensive featured-price-and-volume block chart. An investor is able to determine the similarity value of the combined featured-price-and-volume block information message and non-combined featured-price-and-volume level information message according to the level-and-block similarity value to modify the reasonable combination conditions. A method for calculating the similarity value is implemented by cosine similarity.

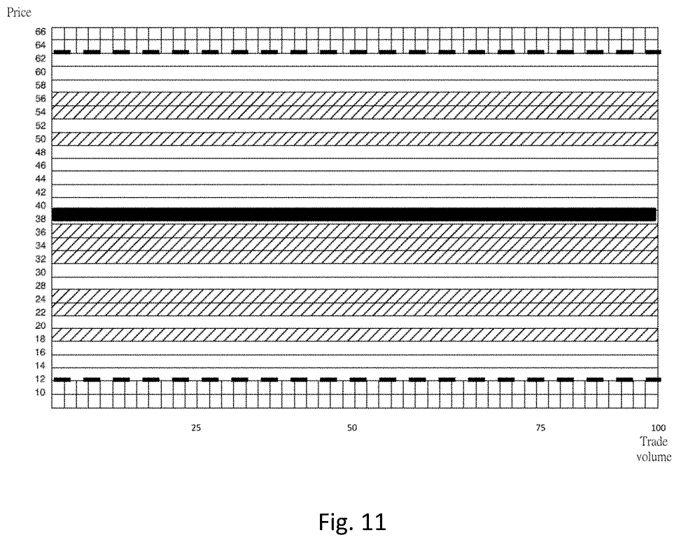

The processing unit 10 further comprises a long-term-average-price displaying module 30 electrically connected to the information receiving module 14, the customized combination module 16 and the information displaying module 21. When the user operates the customized combination module 16 to generate a long-term average price display information message to the long-term-average-price displaying module 30, the long-term-average-price displaying module 30 may generate a long-term average price information message according to financial information messages of the financial instruments of the collected information receiving module 14 and transmit the long-term average price information message to the information displaying module 21 to combine with the featured-price-and-volume block information message to generate a comprehensive featured-price-and-volume block chart. The long-term average price information message may be a year average price line, a half year average price line, a quarter average price line, etc. The long-term average price information message, as shown in FIG. 11, illustrates long-term average price in forms of bars with different colors or patterns. The present invention indicates the long-term average price information message with black bars. Furthermore, after generating long-term average price information message, the long-term-average-price displaying module 30 further transmits the long-term average price information message to the combining-and-generating module 20 such that the combining-and-generating module 20 deems the long-term average price information message as a featured price to combine with the featured price level bars to form featured-price-and-volume block. In the embodiment, the featured-price-and-volume level module 18 connected between the long-term-average-price displaying module 30 and combining-and-generating module 20 for quantizing the long-term average price information message to full-length level bar, too.

The processing unit 10 further comprises an expected return estimating module 34 connected to the combining-and-generating module. With reference to FIG. 7, zero volume full volume block Z is located between a first full volume block F1 corresponding to a first price interval (ex. 1837) and a second full volume block F2 corresponding to a second price interval (4957) higher than the first price interval. The volumes of the first full volume block F1 and second full volume block F2 are quite large, and therefore the first full volume block F1 and second full volume block F2 can be denoted as correction area. Thus, the expected return estimating module 34 can determine a highest price H of the first price interval as an entry point of the tradable object and determine a lowest price L of the second interval as an exit point of the tradable object and estimates an expected return R between the highest price H and the lowest price Z.

The comprehensive featured-price-and-volume block chart generated by the information displaying module 21 is composed of any one of the information messages or a combination thereof generated by the combining-and-generating module 20, the level-and-block comparing module 26, the time interval displaying module 28, the long-term-average-price displaying module 30, and the featured-price-and-volume block comparing module 32. The chart is generated based on the user's selection to the information messages.

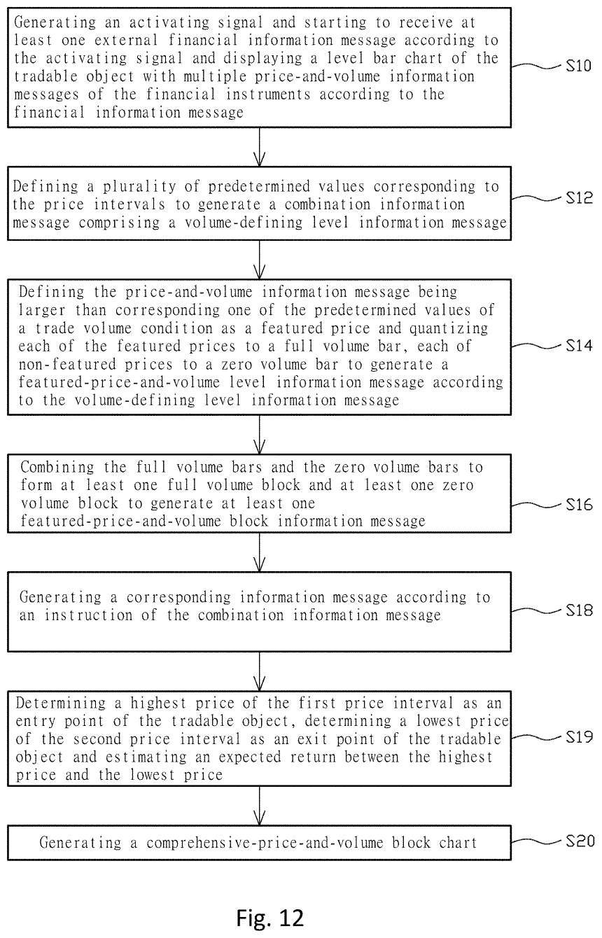

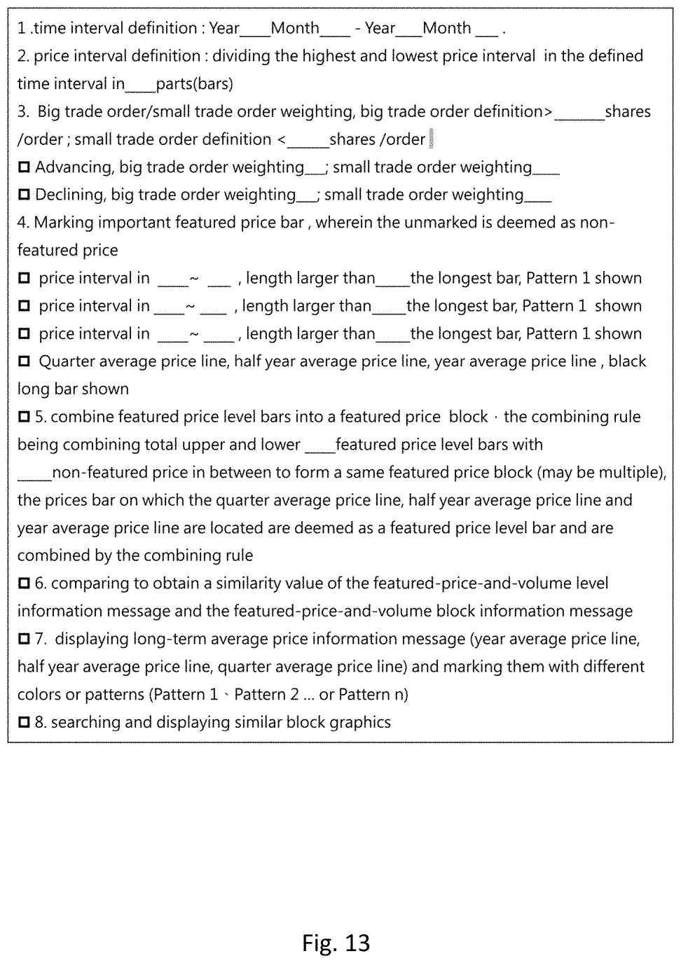

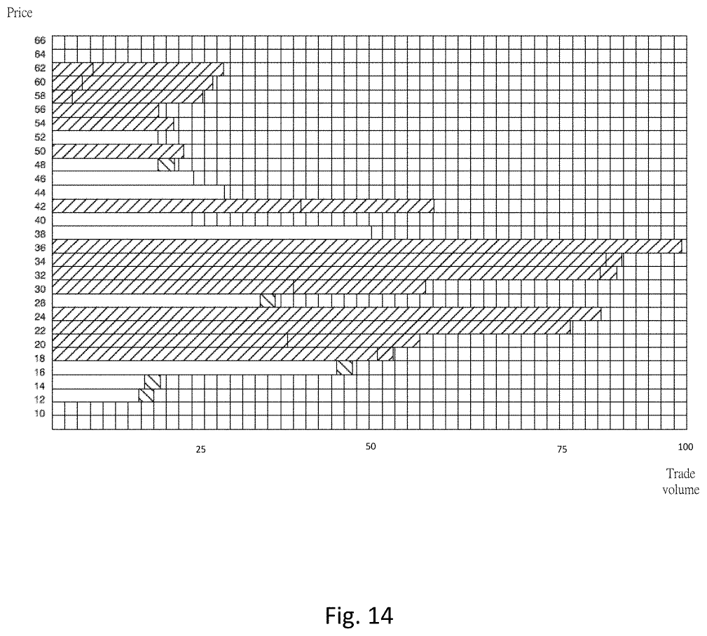

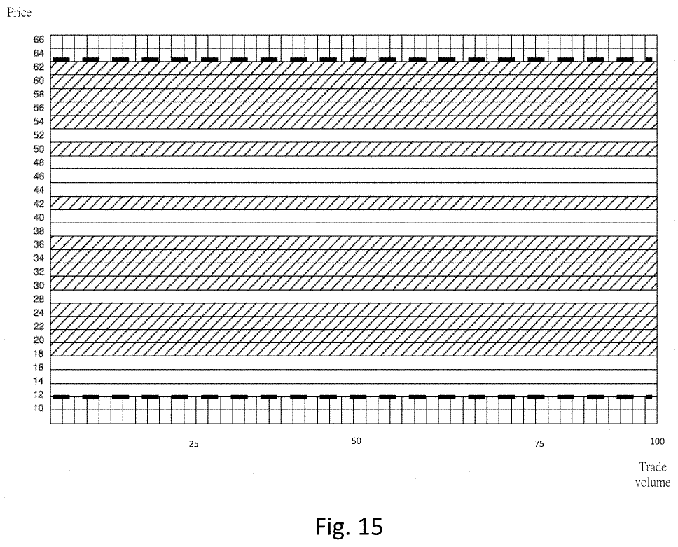

After explanation of structure of the present invention, please refer to the flowcharts of FIGS. 2 and 12. As shown in the figures is a trade data processing method for financial instruments. First, a step S10 is implemented, computer 1 is operated to transmit an activating signal, the information receiving module 14 starts to receive financial information message of at least one external financial instrument according to the activating signal, and a level bar chart of the tradable object with multiple price-and-volume information messages of the financial instruments are displayed according to the financial information message. The multiple price-and-volume information messages are segmented to a plurality of volume bars corresponding to a plurality of price intervals, ex. Over 30 volume bars. Then, a step S12 is implemented, the customized combination module 16 defining a plurality of predetermined values corresponding to the price intervals to generate a combination information message comprising a volume-defining level information message. In the embodiment, the customized combination module 16 generates and displays multiple displayed information options in the display 12. The way that the multiple displayed information options are displayed in the display 12 is shown in FIG. 13 to allow a user to select at least one of the displayed information options to generate a combination information message such that a trade volume-defining level information message, a weighting module information message, a featured-price-and-volume block comparison information message, a level-and-block comparison information message or a long-term average price display information message is accordingly generated according to the selected information option. For example, a definition of the present invention is as follows. With reference to FIG. 13, when the step S12 is implemented: First, Field 1 is selected, and a time interval from 2014/09 to 2016/03 is defined; Field 2 is selected, and a price interval of the financial instruments illustrated is between 10-66 and is divided into 30 equal parts; Field 3 is selected, weighting is performed according to the big trade order or small trade order of the financial instruments, and the user is able to define the big trade order and the trade small order with different weights. For example, the present embodiment defines that big trade order is an order greater than an average shares/order, and small trade order is an order less than an average shares/order; Field 4 is selected, and it is defined that in a price interval, a price being larger than a predetermined value of a trade volume condition is set as a featured price. For example, the present embodiment defines that a trade volume of a predetermined value of a trade volume condition for a price from 18 to 40 being 50 is illustrated as a featured price, and the featured price is illustrated in form of Pattern 1. Furthermore, a trade volume of a predetermined value of a trade volume condition for a price from 50 to 64 being 25 is illustrated as a featured price, and the featured price is illustrated in form of Pattern 1; Field 5 is selected, five adjacent featured prices level bars with two intervening non-featured prices are combined to form a block (multiple blocks are available), and the quarter average price line, half year average price line or year average price line are deemed as a featured price and combined with the combining rule; and Field 7 is selected, and the long-term average price information messages (the year average price line, half year average price line and quarter average price line) are illustrated with marks of different patterns (Pattern 1, Pattern 2 . . . and Pattern n), and the long-term-average-price displaying module 30 is able to generate a long-term average price information message according to financial information messages of the financial instruments. Then the step S14 is implemented. The featured-price-and-volume level module 18, according to the predetermined value of the trade volume condition of the trade volume-defining level information message of the combination information message, determines whether the price-and-volume information message is a featured price to generate featured-price-and-volume level information message. Because the case of the present embodiment performances the weighting process in advance, as shown in FIG. 10, the featured-price-and-volume level module 18 therefore determines according to the weighted price-and-volume information message. The present embodiment defines that a trade volume of a predetermined value of a trade volume condition for a price from 18 to 40 is 50 and a trade volume of a predetermined value of a trade volume condition for a price from 50 to 64 is 25. A determined featured price is shown in FIG. 14, and the bar graphics pertinent to the featured price are painted with Pattern 1. The featured-price-and-volume level module 18 then integrates and quantizes the featured price level bars to generate a featured-price-and-volume level information message (level bar chart). The featured-price-and-volume level information message is shown in FIG. 15, and a first quantization process is completed.

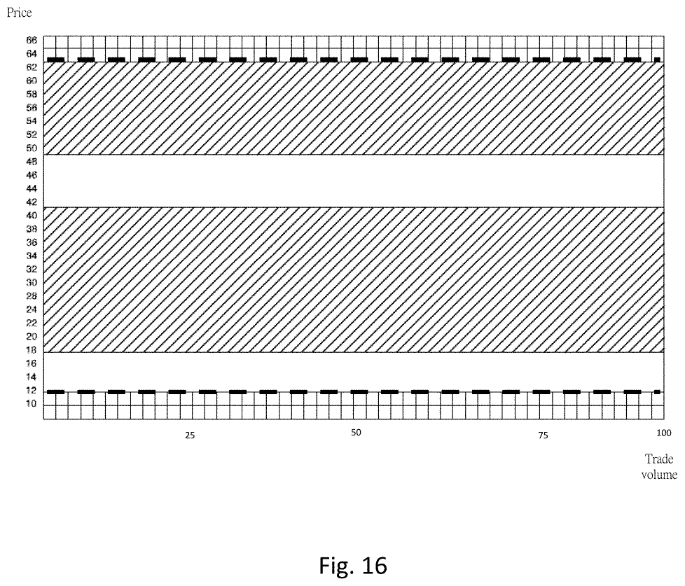

Then the step S16 is implemented. A second quantization process is implemented such that the full-length level bars and the zero-length level bars are combined to form at least one full volume block and at least one zero volume block. The combining-and-generating module 20 combines the multiple featured price level bars to form at least one featured-price-and-volume block according to the aforementioned conditions. The example of the present embodiment defines that during the implementation of the step S12, Field 5 is selected, and five adjacent featured prices level bars with two intervening non-featured prices are combined to form a block (multiple blocks are available), and the quarter average price line, half year average price line or year average price line are deemed as a featured price and combined with the combining rule. Therefore, the featured-price-and-volume block information message (block chart) is presented as in FIG. 16. In other words, when a number of the featured prices level bars adjacent to the non-featured prices are totally five, two or less non-featured prices are combined and dismissed. During the process, first, one of the non-featured prices between the adjacent featured prices level bars is combined to form a featured-price-and-volume block, and then two adjacent non-featured prices between the adjacent featured prices level bars are combined to form a featured-price-and-volume block to generate a combined featured-price-and-volume block information message. Moreover, a number of the non-featured prices between the adjacent featured prices level bars may be determined by the combining-and-generating module 20 according to a number of price-and-volume information messages of the financial instruments. The more the number of the price-and-volume information messages is, the more the combined non-featured prices are. Furthermore, a number of the featured prices level bars adjacent to the combined non-featured price is more. For example, when a number of the price-and-volume information message intervals of the financial instruments is 100, the combined non-featured prices are five or less. However, a number of the featured prices level bars adjacent to the combined non-featured prices must be seven or more.

Then the step S18 is implemented. A corresponding information message is generated according to an instruction of the combination information message generated from the selected displayed information option in the aforementioned step S12. Furthermore, when Field 6 is selected in the definition interval of the step S12 to compare to obtain a similarity of the featured-price-and-volume level information message and featured-price-and-volume block information message, a featured-price-and-volume block is generated after the step S14 and step S16, and in the step S18 the level-and-block comparing module 26 is able to timely generate a similarity comparing the featured-price-and-volume level information message(level bar chart) the featured-price-and-volume block information message(block chart) to generate a level-and-block similarity value. The comparing method has been described as above and will not be repeated. When Field 8 is selected in the definition interval of the step S12 to find out and classify similar graphic financial instruments, in other words, similarity of the featured-price-and-volume block information messages of the different financial instruments is displayed and compared, a featured-price-and-volume block is generated after the step S14 and the step S16, the step S18 is able to timely generate a block similarity value by the featured-price-and-volume block comparing module 32 to compare to obtain a similarity of the featured-price-and-volume block information message of the different financial instruments. The comparing method has been described as above and will not be repeated.

Then the step S19 is implemented. With reference to FIG. 7 above described, when one of the zero volume full volume blocks located between a first full volume block corresponding to a first price interval and a second full volume block corresponding to a second price interval higher than the first price interval, the expected return estimating module determines a highest price of the first price interval as an entry point of the tradable object, determines a lowest price of the second price interval as an exit point of the tradable object and estimates an expected return between the highest price and the lowest price.

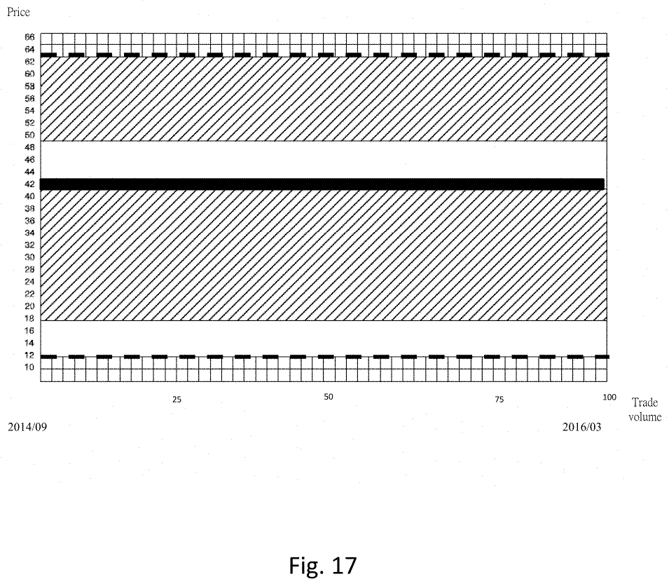

Then the step S20 is implemented. A combination is implemented according to the information messages selected by the user to generate a comprehensive featured-price-and-volume block chart. According to the contents as defined by the aforementioned embodiments, the comprehensive featured-price-and-volume block chart finally displayed in the display 12 by the present embodiments is shown in FIG. 17. Alternatively, the chart may be composed of any one of the information messages or a combination thereof generated from the weighting module 22, the level-and-block comparing module 26, the time interval displaying module 28, the long-term-average-price displaying module 30, and the featured-price-and-volume block comparing module 32.

As described above, the present invention synchronously combines the past information messages of historical trade price and historical trade volume of the financial instruments that takes completely two-dimensional data into account. By two quantization processes, the two-dimensional data is turned into a featured-price-and-volume block information message. The featured-price-and-volume block information message indicates a consolidation period of price fluctuation of the financial instruments. In such period the price fluctuation indicates stalemate and chaos. When the price fluctuation of the financial instruments is escaping from the featured-price-and-volume block, the consolidation period condition, the price movement of the financial instruments is effectively determined no matter which of a start point or stop point of an advancing trend or declining trend the price movement undergoes, which facilitates an investor to read the information, effectively assists the investor and enhances investing profit of the financial instruments. Therefore, the intelligent Volume Profile charting device and method thereof can objectively charting Volume Profile chart or Volume-by-Price chart, such investors could invest tradable objects more efficiently and effectively based on intelligent charts and calculations of entry point, exit point and expected return.

The aforementioned description is merely preferred embodiments of the present invention and are not used to limit the scope of the present invention. Therefore, any equivalent variation or modification complying with the features and the spirits of the claims of the present invention should be included scope of the claims of the present invention.

What is claimed is:

1. An intelligent Volume Profile charting device for charting a tradable object of financial instruments applied to a computer with a display comprising:
an information receiving module receiving a financial information message of at least one external financial instrument;
a price-and-volume displaying module displaying a level bar chart of the tradable object with multiple price-and-volume information messages of the financial instruments according to the financial information message, wherein the multiple price-and-volume information messages are segmented to a plurality of volume bars corresponding to a plurality of price intervals;
a customized combination module defines a plurality of predetermined values corresponding to the price intervals to generate a combination information message, wherein the combination information message comprises a volume-defining level information message;
a featured-price-and-volume level module receiving the multiple price-and-volume information messages, and defining the price-and-volume information message being larger than corresponding one of the predetermined values of a trade volume condition as a featured price, wherein the featured-price-and-volume level module quantize each of the featured prices to a full-length level bar and quantize each of non-featured prices to a zero-length level bar to generate a featured-price-and-volume level information message according to the volume-defining level information message of the combination information message;
a combining-and-generating module combining the full-length level bars and the zero-length level bars of the featured-price-and-volume level information message into at least one full volume block and at least one zero volume block to generate a featured-price-and-volume block information message; and
an information displaying module generating and displaying a comprehensive featured-price-and-volume block chart in the display according to the financial information message, the featured-price-and-volume level information message, and the featured-price-and-volume block information message.

2. The intelligent Volume Profile charting device as claimed in claim 1, wherein the combination information message further comprises a weighting module information message, a featured-price-and-volume block comparison information message, a level-and-block comparison information message, a long-term average price display information message or a time interval display information message.

3. The intelligent Volume Profile charting device as claimed in claim 2 further comprising a weighting module, wherein when the customized combination module generates the weighting module information message to weighting module, the weighting module weights and adjusts a trade volume of the price-and-volume information message, when a price of the financial instruments decreases, the weighting module gives a negative weighting setting value to a trade volume of a small trade order of the financial instruments and gives a positive weighting setting value to a trade volume of a big trade order of financial instruments, then the featured-price-and-volume level module defines the multiple weighted price-and-volume information messages; when the price of the financial instruments increases, the weighting module gives a positive weighting setting value to a trade volume of a small trade order of the financial instruments and gives a negative weighting setting value to a trade volume of a big trade order of financial instruments, then the featured-price-and-volume level module defines the multiple weighted price-and-volume information message, wherein the small trade order and the big trade order are defined by a user.

4. The intelligent Volume Profile charting device as claimed in claim 2 further comprising a time interval displaying module, wherein when the customized combination module generates time interval display information message to the time interval displaying module, a time interval is generated and transmitted to the information displaying module according to a time interval set by the time interval display information message.

5. The intelligent Volume Profile charting device as claimed in claim 4 further comprising a featured-price-and-volume block chart comparing module, wherein when the customized combination module generates featured-price-and-volume block charts comparison information message to the featured-price-and-volume block comparing module corresponding to different time intervals generated by the time interval displaying module, block chart similarity values between every two of the different featured-price-and-volume block information messages are obtained by comparison to generate and transmit mean values of the block chart similarity values corresponding to the different time intervals respectively to the information displaying module for determining an optimized time interval according to the mean values of the block chart similarity values.

6. The intelligent Volume Profile charting device as claimed in claim 2 further comprising a long-term-average-price displaying module, wherein when the customized combination module generates the long-term average price display information message to long-term-average-price displaying module, the long-term-average-price displaying module generates and transmits a long-term average price information message to the information displaying module.

7. The intelligent Volume Profile charting device as claimed in claim 6, wherein after the long-term-average-price displaying module generates long-term average price information message, the long-term average price information message is further transmitted to the combining-and-generating module to combine the long-term average price information message which is deemed as another featured price with the full-length level bars to form the featured-price-and-volume block.

8. The intelligent Volume Profile charting device as claimed in claim 1, wherein the combining-and-generating module combining the multiple featured prices level bars to form the featured-price-and-volume block combines adjacent full-length level bars and adjacent zero-length level bars or combines two full-length level bars between which at least one zero-length level bar is located to generate the featured-price-and-volume block information message.

9. The intelligent Volume Profile charting device as claimed in claim 1, further comprising an expected return estimating module, when one of the zero volume full volume blocks located between a first full volume block corresponding to a first price interval and a second full volume block corresponding to a second price interval higher than the first price interval, the expected return estimating module determines a highest price of the first price interval as an entry point of the tradable object, determines a lowest price of the second price interval as an exit point of the tradable object and estimates an expected return between the highest price and the lowest price.

10. The intelligent Volume Profile charting device as claimed in claim 1, wherein the price-and-volume displaying module segments the multiple price-and-volume information messages to over 30 volume bars.

11. The intelligent Volume Profile charting device as claimed in claim 1, wherein the customized combination module defines the predetermined values according to a normal distribution.

12. An intelligent Volume Profile charting method for charting a tradable object of financial instruments comprising steps as follows:
(a) generating an activating signal and starting to receive at least one external financial information message according to the activating signal and displaying a level bar chart of the tradable object with multiple price-and-volume information messages of the financial instruments according to the financial information message, wherein the multiple price-and-volume information messages are segmented to a plurality of volume bars corresponding to a plurality of price intervals;
(b) defining a plurality of predetermined values corresponding to the price intervals to generate a combination information message comprising a volume-defining level information message;
(c) defining the price-and-volume information message being larger than corresponding one of the predetermined values of a trade volume condition as a featured price and quantizing each of the featured prices to a full-length level bar, each of non-featured prices to a zero-length level bar to generate a featured-price-and-volume level information message according to the volume-defining level information message;
(d) combining the full-length level bars and the zero-length level bars to form at least one full volume block and at least one zero volume block to generate at least one featured-price-and-volume block information message; and
(e) generating a comprehensive featured-price-and-volume block chart according to the financial information message, the featured-price-and-volume level information message and the featured-price-and-volume block information message.

13. The intelligent Volume Profile charting method as claimed in claim 12, wherein before the step (c), weighting and adjusting a trade volume of the price-and-volume information message, when a price of the financial instruments decreases, a negative weighting setting value is given to a trade volume of a small trade order of the financial instruments and a positive weighting setting value is given to a trade volume of a big trade order of financial instruments; when the price of the financial instruments increases, a positive weighting setting value is given to a trade volume of a small trade order of the financial instruments and a negative weighting setting value is given to a trade volume of a big trade order of financial instruments, wherein the small trade order and the big trade order are defined by a user.

14. The intelligent Volume Profile charting method as claimed in claim 12, wherein after the step (d), setting a time interval to display the time interval.

15. The intelligent Volume Profile charting method as claimed in claim 14, wherein after the step (d), comparing to obtain block chart similarity values between every two of the featured-price-and-volume block information messages to generate mean values of the block charts similarity values corresponding to different time intervals.

16. The intelligent Volume Profile charting method as claimed in claim 14, wherein before the step (d), generating a long-term average price information message then implementing the step (d) to combine the long-term average price information message, the full-length level bars and the zero-length level bars to form the featured-price-and-volume block information message.

17. The intelligent Volume Profile charting method as claimed in claim 14, wherein after the step (d), generating a long-term average price information message and displaying the long-term average price information message.

18. The intelligent Volume Profile charting method as claimed in claim 14, wherein the step (d) combining the featured prices level bars to from the at least one featured-price-and-volume block combines adjacent full-length level bars and adjacent zero-length level bars or combines two full-length level bars between which at least one zero-length level bar is located to generate the featured-price-and-volume block information message.

19. The intelligent Volume Profile charting method as claimed in claim 14, further comprising:
when one of the zero volume full volume blocks located between a first full volume block corresponding to a first price interval and a second full volume block corresponding to a second price interval higher than the first price interval, determining a highest price of the first interval as an entry point of the tradable object, determining a lowest price of the second price interval as an exit point of the tradable object and estimating an expected return between the highest price and the lowest price.

20. The intelligent Volume Profile charting method as claimed in claim 14, wherein in the step (b), the predetermined values according to a normal distribution.
